(19) United States
(12) Patent Application Publication
(10) Pub. No.: US 2013/0263381 A1
(43) Pub. Date: Oct. 10, 2013

(54) Corkscrew

(71) Applicant: Yuriy Zakuskin, Orekhov (UA)

(72) Inventor: Yuriy Zakuskin, Orekhov (UA)

(21) Appl. No.: 13/441,096

(22) Filed: Apr. 6, 2012

(51) Int. Cl. B67B 7/04

(52) U.S. Cl. 7/155

(57) ABSTRACT

A corkscrew having a handle attached to a threaded screw shaft member is described. The screw shaft member includes threads designed to insert into a cork when the handle is twisted. The threaded screw shaft member also includes an air channel having a top opening located near the handle and a bottom opening located near a distal end of the threaded screw shaft member such that when the corkscrew is inserted into a cork, the bottom opening and top opening create an equalized pressure through the air channel such that the inside of the cork experiences the same pressure as the outside of the bottle and thereby eliminating a vacuum that is created when the cork is removed from the neck of the bottle.

Embodiments relate generally to bottle openers, and more particularly, to corkscrews for opening bottles having a cork stopper.

Conventional corkscrews may suffer from a limitation in that a vacuum is created on the inside of the bottle when trying to remove a cork. Some relatively complicated corkscrews or bottle openers have been developed to deal with the vacuum created on the inside when trying to remove a cork. However, these conventional bottle openers may be bulky and cumbersome and may easily stored and/or carried.

An embodiment includes a corkscrew having a handle attached to a threaded screw shaft member. The body member includes threads designed to insert into a cork when the handle is twisted. The threaded screw shaft member also includes an air channel having a top opening located near the handle and a bottom opening located near a distal end of the threaded screw shaft member such that when the corkscrew is inserted into a cork, the bottom opening and top opening create an equalized pressure through the air channel such that the inside of the cork experiences the same pressure as the outside of the bottle and thereby eliminating a vacuum that is created when the cork is removed from the neck of the bottle.

Another embodiment includes a folding corkscrew having a handle attached to a threaded screw shaft via a hinge that permits the threaded screw shaft to rotate relative to the handle. The screw shaft member includes threads designed to insert into a cork when the handle is twisted. The threaded screw shaft member also includes an air channel having a top opening located near the handle and a bottom opening located near a distal end of the threaded screw shaft member such that when the corkscrew is inserted into a cork, the bottom opening and top opening create an equalized pressure through the air channel such that the inside of the cork experiences the same pressure as the outside of the bottle and thereby eliminating a vacuum that is created when the cork is removed from the neck of the bottle. The folding corkscrew can have a handle and hinge construction similar to that described in U.S. Pat. No. 4,759,238, which is incorporated herein by reference. It will be appreciated that other designs and constructions of the handle and hinge could be used.

### BRIEF DESCRIPTION OF THE DRAWINGS

FIG. 1 shows a diagram of an example corkscrew in accordance with at least one embodiment.

FIG. 2 shows a diagram of an example corkscrew inserted into a cork in the top of a bottle.

### DETAILED DESCRIPTION

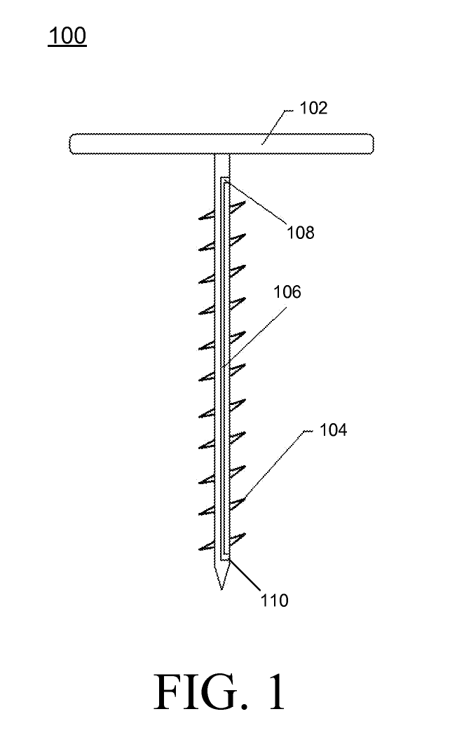

As shown in FIG. 1, an example corkscrew 100 has a handle 102 a threaded screw shaft (or body) member 104 having an air channel disposed inside the threaded screw shaft, the air channel 106 in communication with a top opening 108 disposed near the joint where the handle and screw shaft meet and a bottom opening 110 disposed near a distal end of the screw shaft.

The handle and/or screw shaft can be made of any suitable material such as metal or plastic. Suitable metals can include aluminum, steel, brass, bronze or the like. The handle can also be made of wood.

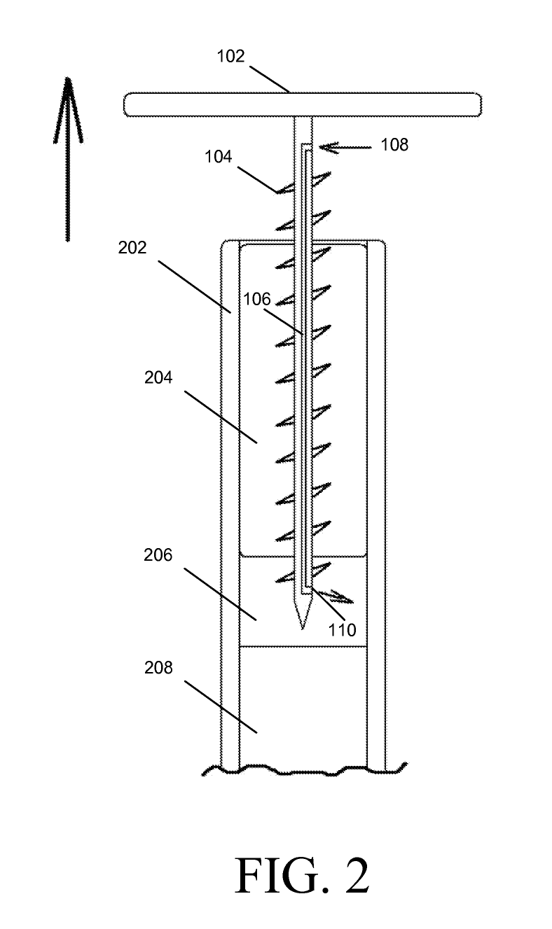

As shown in FIG. 2, in operation, the corkscrew screw shaft 104 is inserted into the cork 204 in the top of the bottle 202 of wine 208 or other liquid. Once inserted into the cork 204, the air channel 106 of the threaded screw shaft 104 equalizes the pressure between the space 206 under the cork and the air outside the wine bottle.

It is, therefore, apparent that there is provided, in accordance with the various embodiments disclosed herein, corkscrews having a screw shaft with an internal air channel in communication with a top opening and a bottom opening.

While the invention has been described in conjunction with a number of embodiments, it is evident that many alternatives, modifications and variations would be or are apparent to those of ordinary skill in the applicable arts. Accordingly, Applicants intend to embrace all such alternatives, modifications, equivalents and variations that are within the spirit and scope of the invention.

What is claimed is:

1. A corkscrew comprising:
a handle; and
a body member attached to the handle, the body member having an air channel disposed within the body member, the air channel extending from a top opening, disposed near a point where the handle and body are joined, to a bottom opening near a distal end of the body member, the air channel in communication with both the top opening and the bottom opening.

2. The bottle opener of claim 1, wherein the body member includes external threads designed to insert into a cork when the handle is rotated.

3. A bottle opener comprising:
a handle; and
a body member attached to the handle, the body member including external threads designed to insert into a cork when the handle is rotated, the body member having an air channel disposed within the body member.

4. The bottle opener of claim 3, wherein the air channel extends from a top opening, disposed near a point where the handle and body are joined, to a bottom opening near a distal end of the body member, the air channel in communication with both the top opening and the bottom opening.

5. A folding corkscrew comprising:
a handle having a rotational hinge disposed near a midpoint of the handle; and
a body member attached to the handle via the rotational hinge to permit the body member to rotate about the hinge relative to the handle, the body member having an air channel disposed within the body member, the air channel extending from a top opening, disposed near a point where the handle and body are joined, to a bottom opening near a distal end of the body member, the air channel in communication with both the top opening and the bottom opening.

6. The folding corkscrew of claim 5, wherein the body member includes external threads designed to insert into a cork when the handle is rotated.
